(19) United States
(12) Patent Application Publication
(10) Pub. No.: US 2003/0110106 A1
(43) Pub. Date: Jun. 12, 2003

(54) System and method for enabling content providers in a financial services organization to self-publish content

(76) Inventors: Sanjay Deshpande, Emerson, NJ (US); Meaghan C. Williams, Chatham, NJ (US); Kitty C. Chen, Manhasset, NY (US); Ajoy C. Banerjee, New York, NY (US)

Correspondence Address: Leslie Gladstone Restanio, Esq., Brown Raysman Millstein Felder & Steiner LLP, 4th Floor, 55 Madison Avenue, Morristown, NJ, 07960, US

(21) Appl. No.: 10/008,269

(22) Filed: Dec. 10, 2001

(51) Int. Cl. G06F 17/60

(52) U.S. Cl. 705/35; 705/36

(57) ABSTRACT

Content providers, such as research departments in a financial services organization that prepare research reports, can use a Content Management Application (CMA) to self-publish content to a network. Users, such as internal users, e.g., financial advisors, and external users, such as the organization's clients, can access the content via the network. An administrator uses the CMA to define a hierarchy of nodes, and to entitle specific content providers to upload content to specified nodes. The content providers may entitle their content to certain platforms and user groups. The content providers can directly publish content to make it readily available, and thereby feature the latest research or other information. The content providers can update links on the display to link to new or updated content. A Content Display Application (CDA) is used to display the appropriate content to the entitled users.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

Various computerized applications have been used by financial service organizations to disseminate finance-related information. For example, U.S. Pat. No. 5,864,871 discloses an information delivery system and method including on-line entitlements. The system allows brokerage and investment banking firms to distribute reports to investors electronically, and on a controlled basis. The system also allows corporations to electronically distribute annual reports and other financial/investment documents to shareholders and investment advisors. However, there is no provision for enabling content providers in a financial service organization to self-publish content.

There accordingly remains a need in the art for a system and method that addresses the above and other issues.

### SUMMARY OF THE INVENTION

In accordance with the present invention, there is provided a system and method that enables content providers to self-publish content for access via an on-screen display of a computer workstation. The invention is particularly useful, for example, by a financial services organization as allows content providers to feature finance-related research on the display for use by a financial advisor or a client. Advantageously, the content providers can independently update and promote information to users in a communications network in an efficient manner. Moreover, the content providers can associate entitlement data with information to restrict access where necessary.

Generally stated, self-published content offered by the present invention includes financial services-related information, such as research reports on securities. The reports may be displayed on a user's computer workstation, with other information such as general business news and real-time or near real-time live data such as a stock ticker. The research may relate to different financial instruments, such as equities, taxable fixed income securities, and municipal (e.g., non-taxable) securities. Moreover, the content provider may provide content research, articles, news and other information that is tailored to each type of financial instrument. Furthermore, for a given financial instrument (e.g., a particular stock), specific content such as research, headlines, statistics such as charts, and ratings can be provided. Additionally, information can be provided that identifies the clients of a financial services organization that currently hold the designated security. In this way, a user such as a financial advisor can access the latest updated information and client marketing information to allow the user to better serve the organization's clients. In accordance with the invention, content is presented uniformly to provide ease of use. Moreover, the published content may be made available to users outside of the organization, such as the organization's clients, via, e.g., a web browser.

The content providers, which may be groups or other entities in a financial services organization, can directly self-publish and manage their content so that it is available on an on-screen display. The content providers can also control access to content using entitlements. Accordingly, the invention avoids delays that would otherwise result if the publishing process relied on an intermediary to receive, implement and verify the content prior to making it available to the intended audience.

Content from the different content providers may be configured for display simultaneously on a composite screen, with different areas of the screen displaying content from different groups. Conversely, information from different content providers may be displayed on separate, easily navigated, screens.

In order to manage the content from different content providers in the organization, a hierarchy of nodes is created according to subject area and other criteria, with the information from the different content providers uploaded to specified nodes. The invention also enables content providers to dynamically add new on-screen areas, publish content to multiple platforms, and entitle content by platform, user or other criteria.

Accordingly, the present invention provides a method of providing financial services data in a communications network that includes providing a content management application that defines a hierarchy of nodes including topic nodes arranged by topic, and enables a plurality of different content providers to publish financial services-related content by uploading content to specified ones of the nodes via the communications network. The method also provides a content display application for displaying the uploaded content on a computerized workstation in the communications network via an onscreen display.

A corresponding system and computer program product are also provided.

### BRIEF DESCRIPTION OF THE DRAWINGS

The invention is illustrated in the figures of the accompanying drawings, which are meant to be exemplary and not limiting, in which like references are intended to refer to like or corresponding elements, and in which:

FIG. 1 illustrates a high-level overview of a system in accordance with the present invention;

FIG. 2 illustrates a system architecture overview;

FIG. 3 illustrates an example on-screen user interface/display;

FIG. 4 illustrates an equities report search screen;

FIGS. 5(a)-(d) illustrate equities report screens;

FIG. 6 illustrates a report index page;

FIG. 7 illustrates a custom function page;

FIG. 8 illustrates a home page;

FIG. 9 illustrates a global navigation bar with drop-down box;

FIG. 10 illustrates an example listing of links enabled by group;

FIG. 11 illustrates a hierarchy management screen;

FIG. 12 illustrates a hierarchy management home page node screen;

FIG. 13 illustrates a report display node screen;

FIG. 14 illustrates a topic node screen;

FIG. 15 illustrates a right box node screen;

FIG. 16 illustrates an area node screen;

FIG. 17 illustrates a text node screen;

FIG. 18 illustrates a hierarchy management tree for creating a custom page function node;

FIG. 19 illustrates an image upload screen;

FIGS. 20(a) and (b) illustrate a screen for enabling modification of meta data associated with reports; and

FIG. 21 illustrates a site map user group entitlement screen.

### DETAILED DESCRIPTION OF THE PREFERRED EMBODIMENTS

The present invention provides systems and tools that enable clients, financial advisors, and other users associated with a financial services organization to access financial services related content via a computer network. The invention also enables content providers to self-publish content to the network. Typically, the content is proprietary to the organization and is a key competitive factor in attracting and retaining clients. Providing financial advisors with the latest research reports empowers advisors to speak intelligently to their clients and quickly answer questions. The proprietary information may be combined with information from other sources, such as news bureaus, stock ticker feeds and selected Internet sites. Moreover, the information may be made available directly to the clients, e.g., via a web site.

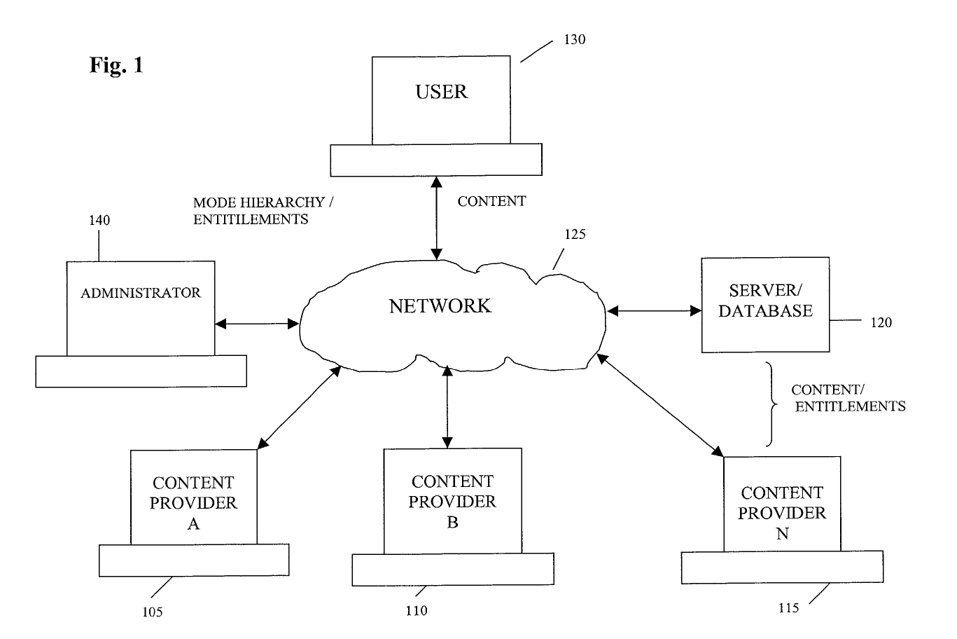

FIG. 1 illustrates a high-level overview of a system in accordance with the present invention. Computer workstations 105, 110, . . . , 115 are used by an organization's content providers to upload research and other content to a server 120 via a network 125. A user 130, such as a financial advisor or client, may then access the content. An administrator workstation 140 performs various functions, e.g., setting entitlements, which allow the content providers to upload files to specific nodes in a hierarchy, as discussed further below.

The invention enables content coordinators to manage content using a Content Management Application (CMA). Content coordinators may be designated employees who manage content in the organization. For example, an organization may have research groups for stocks in the areas of energy, automotive, semiconductors, retail, and so forth. Each group may have a content coordinator to manage the content that is uploaded to a server for access by other users. One or more administrators may also be designated to manage the interaction between the content providers and the CMA. For example, the administrator may designate nodes to which a particular content provider may upload content.

The CMA allows groups in the organization (e.g., business units, departments, and the like) to easily manage new content and report classifications. Content that is uploaded to one or more servers in a network is available to computer workstations on the network. Since the product groups can self-publish content to the network, the latest updated content is quickly made available. Additionally, a Content Display Application (CDA) works in conjunction with the CMA to enable access to the content. The CDA and CMA may be implemented using any known software techniques as will be apparent to those skilled in the art in view of the detailed functionality discussed herein.

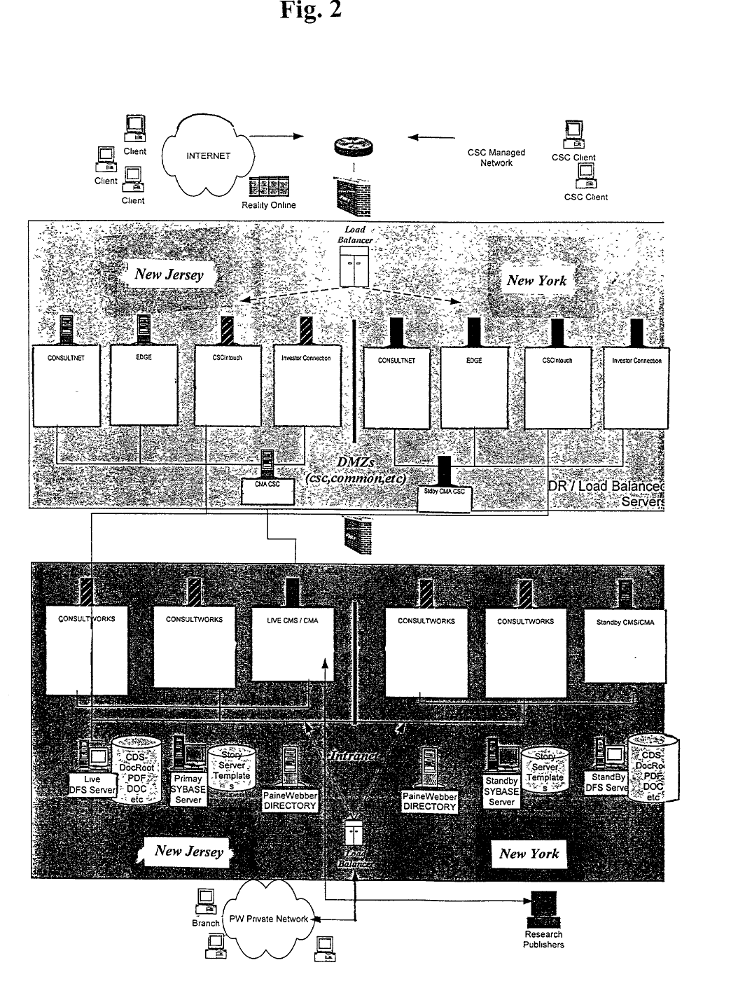

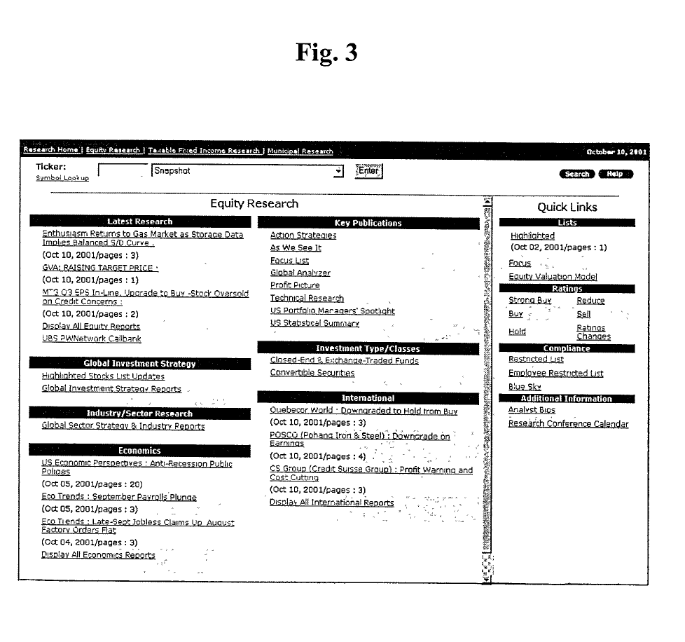

FIG. 2 illustrates a system architecture overview in accordance with the present invention.

The invention may be implemented on any number of different computing platforms. As used herein, the ConsultWorks, ConsultNet, PWOS, Public Web Site, CSCInTouch, and CSC Investor Connection are platforms used by UBS PaineWebber, the present assignee.

The Consultnet, Edge, CSCIntouch, and Investor Connection servers represent examples of various platforms useful to a financial services organization. CSC refers to Correspondent Services Corporation, which provides clearing and execution of trades for outside organizations. Example server specifications include: HTTP Server NES 363 or 4.x, Vignette Story Server CDS (Content Development System), Verity Search Engine, Solaris 2.6 operating environment, DFS (Distributed File System) Client, Sun 45, 4 ways, 1 Gb RAM. The CMA CSC may use a Sun 220R 1 way/512 Mb (Sun Enterprise two-processor workgroup server). In the example implementation, there are two central locations of the organization, one in New Jersey (NJ), one in New York (NY), and a number of additional geographically diverse branch offices. Advantageously, the invention can be adapted to other scenarios, such as with only one central location.

The Consultworks servers and live CMS/CMA servers may have similar specifications as discussed above for the Consultnet, Edge, CSCIntouch, and Investor Connection servers. Here, a live CMS/CMA server is used at one location (NJ), with a standby CMS/CMA server used at the second location (NY). Consultworks is an example of a computer workstation platform that provides various features to a financial advisor, such as access to research, stock prices, news and internal information of the organization. In accordance with the invention, a financial advisor can use the Consultworks platform to access content that is published by various content providers within (and/or outside) the organization. A private network enables branch offices of the financial services organization, where the financial advisors are typically located, to communicate with the central location(s). Proxy caching, as known in the art, may be used to store the published content at distributed locations, such as at the branches, to improve response time.

In addition, clients of the financial services organization may access the published content at the central location(s) via the Internet.

The invention may be implemented using a content management system such as Vignette StoryServer 5.0. This gives the application a robust platform, and the ability to scale and interact with other Vignette StoryServer applications.

The present invention can also be embedded in a computer program product which comprises all the features enabling implementation of the methods and functions described herein, and which, when loaded in a computer system, is able to carry out these methods and functions. Computer program, software program, program, program product, or software in the present context mean any expression, in any language, code or notation, of a set of instructions intended to cause a system having an information processing capability to perform a particular function either directly or after the following: (a) conversion to another language, code or notation; and/or (b) reproduction in a different material form.

With the foregoing overview in mind, reference is made to the exemplary PWER system and method described in detail below.

### I. Content Display Application (CDA)

FIG. 3 illustrates an example on-screen user interface/display in accordance with the present invention. Information content on the system may be broken up into “areas” such as equity research, taxable fixed income research, municipal securities research, research administration, and business teams. as well as a home page. The default launch area is the home page, which can be dynamically updated. From the main menu, it is possible to enter any area at any point in time by clicking on an area “tab” at the top of the screen. Additional areas (tabs) may be dynamically added.

A task bar is provided on the right hand side of the screen. Links to additional information (quick links) are provided for each area. Product group administrators/content providers in each area have the ability to specify, add, or delete such links. The quick links may provide hyperlinks to further content, such as rating of securities (e.g., strong buy, buy, hold, reduce, sell, ratings changes), or links to other topics, e.g., equity valuation model (EVM) ranking, restricted information and employee restricted information.

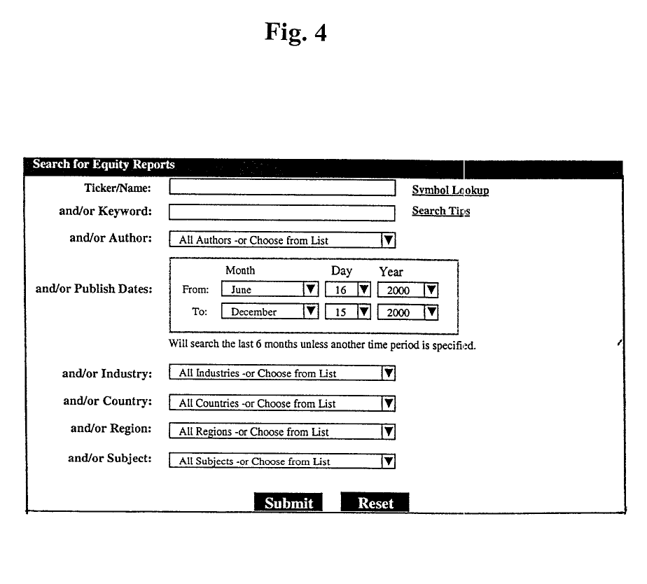

FIG. 4 illustrates an equities report search screen in accordance with the invention. A user may enter a ticker symbol or name of a stock, along with various other criteria, to access the relevant content that has been published. Search screens may also be provided for searching reports of other subjects, such as taxable fixed income municipal securities.

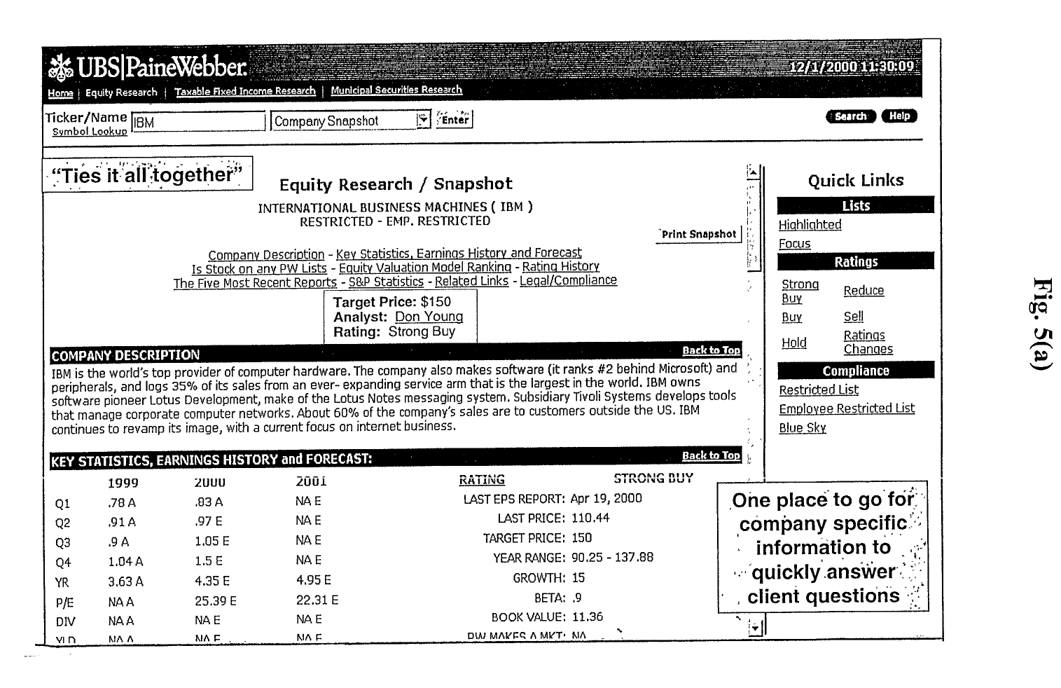

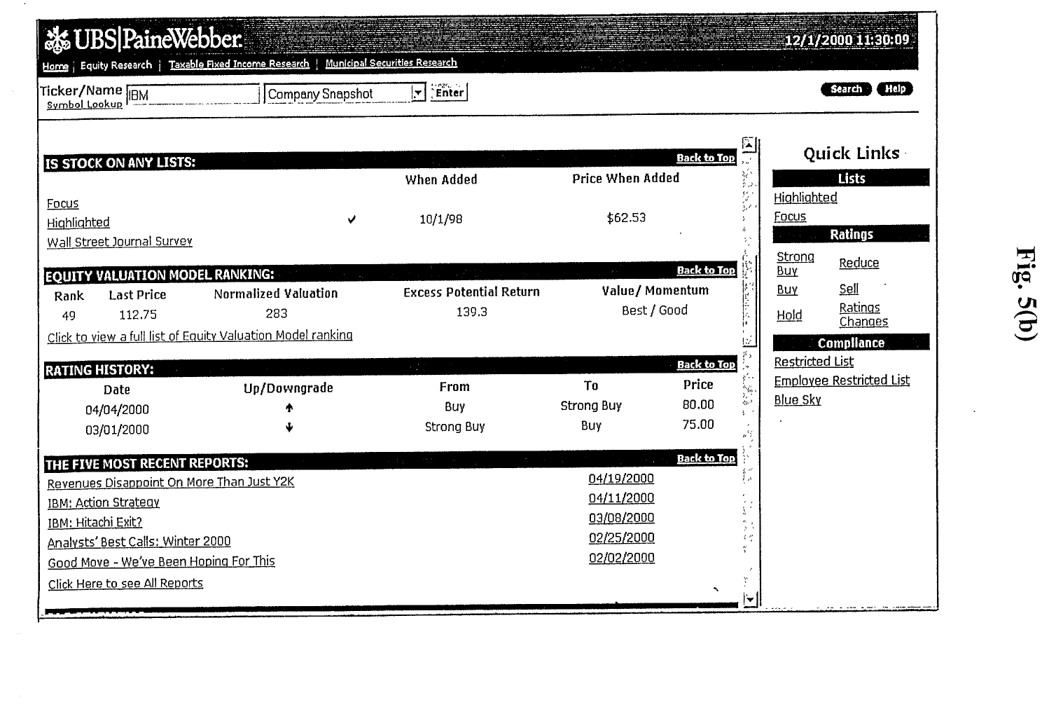

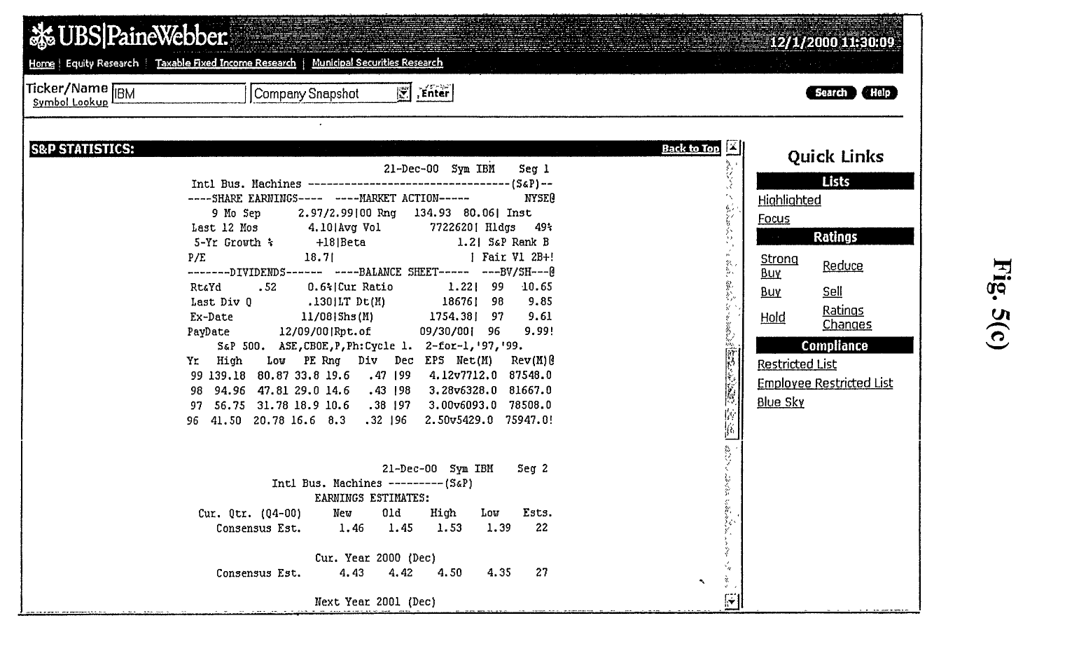

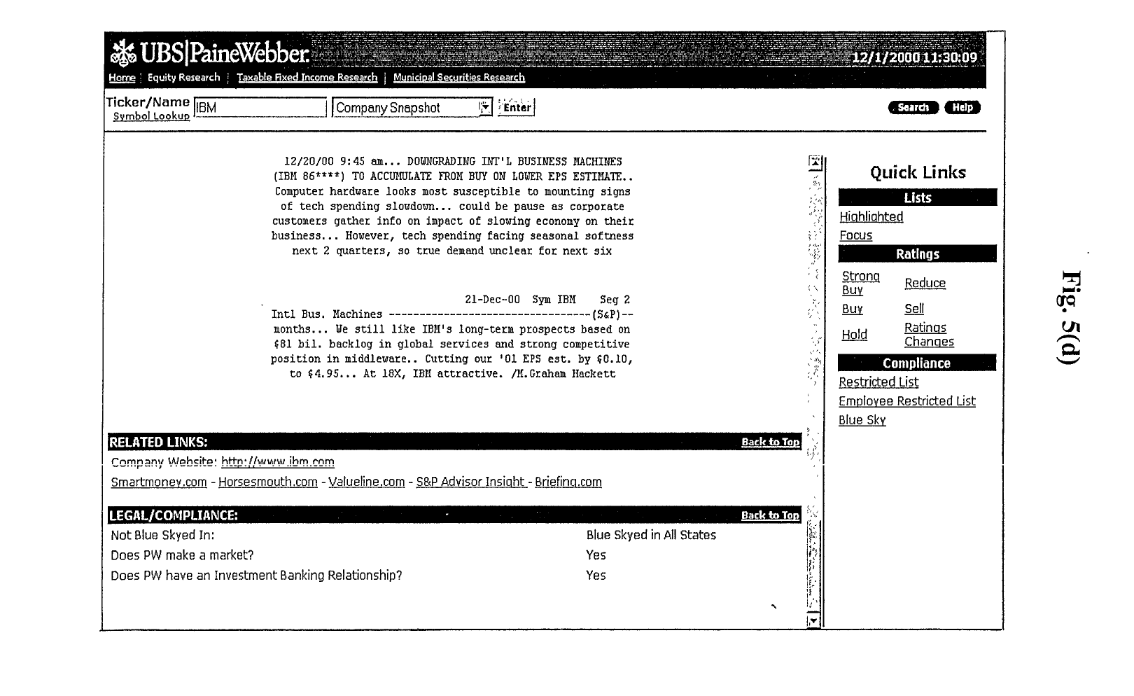

FIGS. 5(a)-(d) illustrate equities report screens in accordance with the invention. For the example stock “IBM”, the report screen of FIG. 5(a) illustrates a snapshot of information that is available, e.g., company description, key statistics, earnings history and forecast, and so forth. The information can be directly accessed by clicking on a hyperlink or by scrolling down the page.

FIG. 5(b) includes links to the most recent reports on the stock, or to all reports, and FIG. 5(d) includes links to external, third party content, such as Internet web sites. All of these links may be dynamically updated.

A right task bar within areas appears if the area has right bar nodes in production (i.e., active/live). As discussed further below, nodes are database locations where content may be published. Nodes may have a status of staging, production, or archived, as discussed further below.

Relevance indicators (price target, ratings; earnings forecast) may be provided, along with icons indicating selected content for primary ticker, and mouseover description of icon. Moreover, the relevance indicators or any other desired content on a screen may be specifically entitled by the same platforms available within the CMA to restrict access.

In addition to text content, content providers may publish streaming audio and video files, e.g., for webcasts.

Referring back to the main menu, these categories may be dynamically created within topic nodes and by using the functionality as built in through design of the CMA. By way of example, main menu categories include: equity, research, taxable fixed income, research and municipal securities research. Other capabilities are also provided, e.g., search and help functions. Advantageously, entitlement filtering will occur for all search results (i.e., no content should ever be returned if the user is not entitled to view the content).

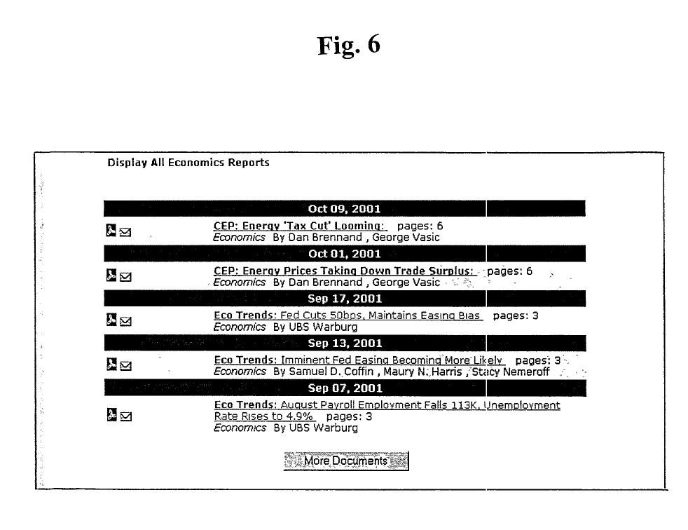

A report index page may be used to display an index of reports selected by the report list index type node discussed in greater detail later (See FIG. 6). When displaying report titles, the number of printed pages in the report is also displayed, along with author and report type. Relevance indicators (price and target, ratings; earnings forecast); icons indicating selected content for primary ticker; mouseover descriptions are displayed as well.

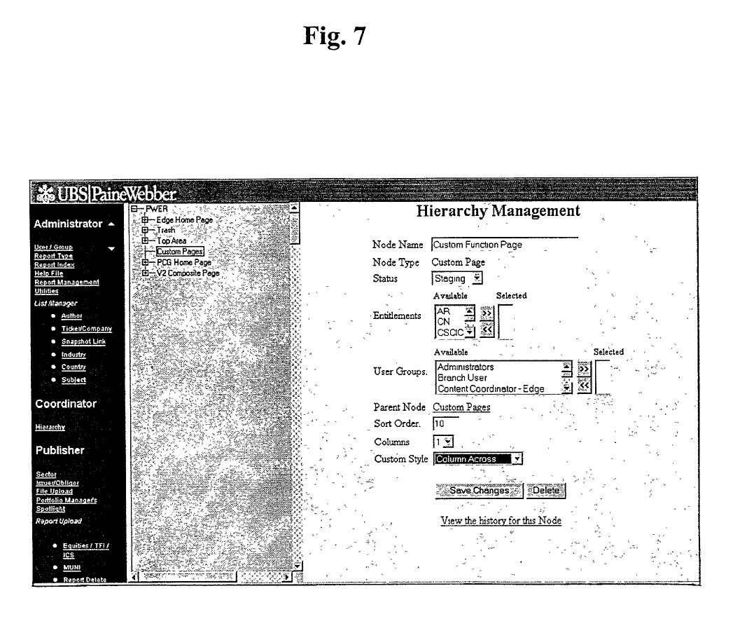

The CMA provides a custom function page that enables a user to access a customized content page from either the Home Page (under listed topics) or area page (e.g., equity research). (See FIG. 7) Upon clicking on a given custom function, the corresponding customized page displays according to the pre-defined style and format set by the content coordinator. The custom function will display only associated topics in sorted order (topics are direct children nodes of the custom function node), from top-to-bottom and then left to right, evenly distributing the number of child topic nodes across the columns (as the home page does).

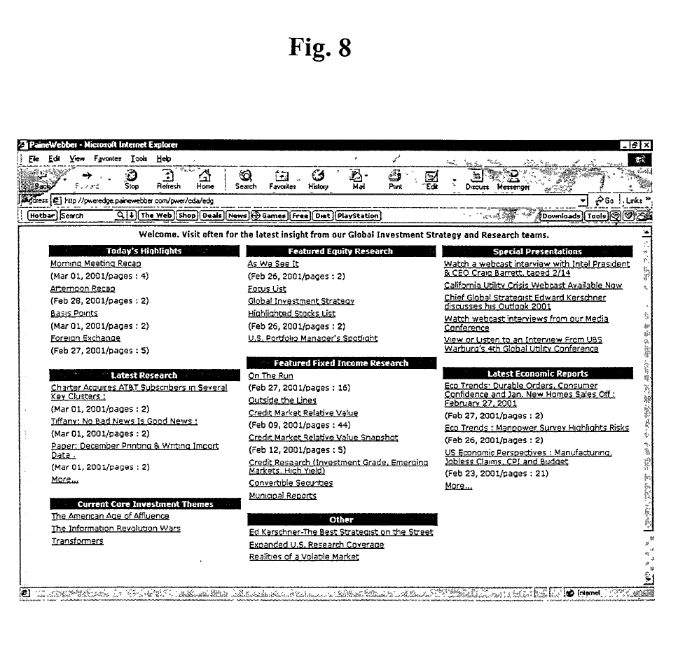

FIG. 8 illustrates a home page in accordance with the present invention. The home page includes two sections. The first section shows a welcome message on the top that can be dynamically edited through a CMA message editor application. The second section is the main body of home page. The number of columns of topics in this section may dynamically change as predetermined by a value set by authorized users. The topics are essentially any subject area. Example topic nodes in this section include “today's highlights,” “latest research” and so forth. Under each topic node, there are several links of different node types, including file, image, text, link, function or report display node.

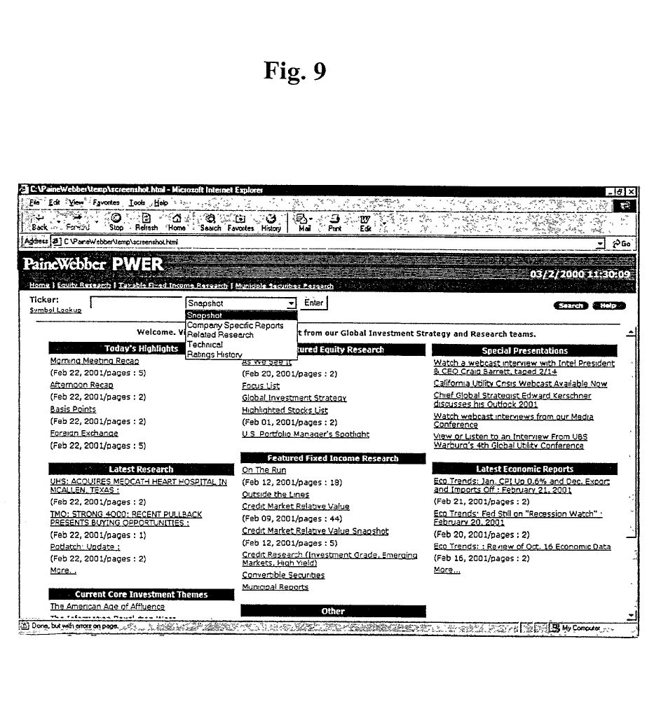

FIG. 9 illustrates a global navigation bar with drop-down box that appears at the top of every screen. A ticker box section with symbol lookup is available on the global navigation bar, and includes a ticker box with symbol lookup, and a drop-down box. A series of options, pertaining to the entered ticker symbol, are provided in the drop-down box, e.g., snapshot, ratings history, company specific reports, related research, and technical research. Conventional search and help buttons are located along the right side of the global navigation bar.

On the top navigation bar of the web page, there are several tabs for area nodes. Of course, the CDA may provide other display functions which are routine in the art.

### II. Content Management Application (CMA)

Generally stated, the CMA provides a tool for hierarchy management, document tagging, linking context and other external information (discussed below).

CMA provides the ability to determine chapters or “areas” represented by tabs along the top of the screen, e.g., areas such as equity research, taxable fixed income (TFI) research, and municipal securities. These can be added/deleted/changed dynamically.

Individual product groups can add/delete/change the topics within pre-defined chapter/areas. For example, in equity research, the product groups or designated administrator can add/delete/change the topic categories displayed. In addition, individual product group administrators have the ability to specify the link displayed in the quick links, as well as the ability to specify links to outside or other internal organization sites to launch webcasts events, and other live multimedia events.

Publishers/administrators can tag the documents or other contents, and update such tags, to indicate entitlement to view the document. The entitlement tag may provide separate entitlements for the organization's public website, and the various internal platforms used by the organization. For each audience (user population), the content provider or administrator is able to set an “available as of” time parameter. For example, it may be established that while the internal employees of the organization can immediately view the document upon publication, the organization's clients should see it with a one day delay, and the organization's public website users should see the same document three days later. That is, one can set delay days for when a document/content is viewable by the platform used in accessing the content. Moreover, new entitlement categories can be added easily, without modifying code. This feature allows the platforms to systematically pull available research documents.

The CMA is used to populate content in the following manner:

(1) From the client workstation, the publisher/content provider uploads content, such as an Adobe Acrobat (PDF) file, to a specified area on a server that will be loaded to the CDA; (2) database tables at the server are updated with the meta information of the report, which may include the report title, search keywords, headline, ticker, and other items discussed elsewhere herein; (3) the PDF document or other content file is placed into a distributed file system (DFS); (4) the index (meta information) to the PDF document or other content file is inserted into the database; and (5) the link to the PDF document or other content file is displayed on the CDA to enable a user to access the content.

Browser Requirements

The CMA and CDA support web browsers such as Internet Explorer 4.0 and higher, Netscape 4.1, AOL browsers on PC and MAC machines, and any other platform browser requirements.

Security Requirements

Accessing the CDA results in entitlement checking. Accordingly, access to the CMA is only permitted via a login procedure.

Entitlements

The entitlement assigned to a node (e.g., hierarchy or content) or report type determines the audience able to view the information. A separate entitlement system is used to get the entitlement level. Details of entitlement level and use are described in U.S. Ser. No. 09/712,358, which is expressly incorporated herein by reference. Entitlement audiences are established for content filtering via the CDA, e.g., based on the various platforms used by the organization. For example, a client accessing a web site may have one entitlement, a financial advisor accessing an internal platform may have another entitlement, an administrator accessing another internal platform may have another entitlement, and so forth.

For each node or content, the invention permits an administrator to designate which of the audiences or combination of audiences may access the published content. Thus, it is possible to customize the groups that may access the content. Additional entitlement audiences can be dynamically added.

External Interfaces

The system interacts with the following external interfaces:

1) MAC (Moves/Adds/Changes) system—An entitlements system that determines the type of access an end user has in the system. The system interacts with MAC on a real-time basis;

2) Scratch pad—a temporary data repository on a PC;

3) Web pad—temporary data repository, browser-based version of the scratch pad, runs on the client and permits access to the scratch pad. A server-based version of web pad performs the same function on the server side; and

4) LDAP—Directory Access Protocol used to retrieve personnel data in database. A real-time interface exists between LDAP and PWER. Scripts are created to retrieve data from the LDAP database for the Feedback function.

The CMA is a browser-based “thin client” which is compliant on a plurality of platforms. Content provider, content coordinator, and branch user entitlements are handled through the CMA. Two levels of entitlement may be used: (1) to provide pre-determined CMA functions which a particular user is entitled (assigning users to groups) and (2) to entitle user groups to nodes within the hierarchy. Only those nodes the user group is entitled to will be displayed and accessible to the user group.

Access Control

(1) User, Group and Password Management

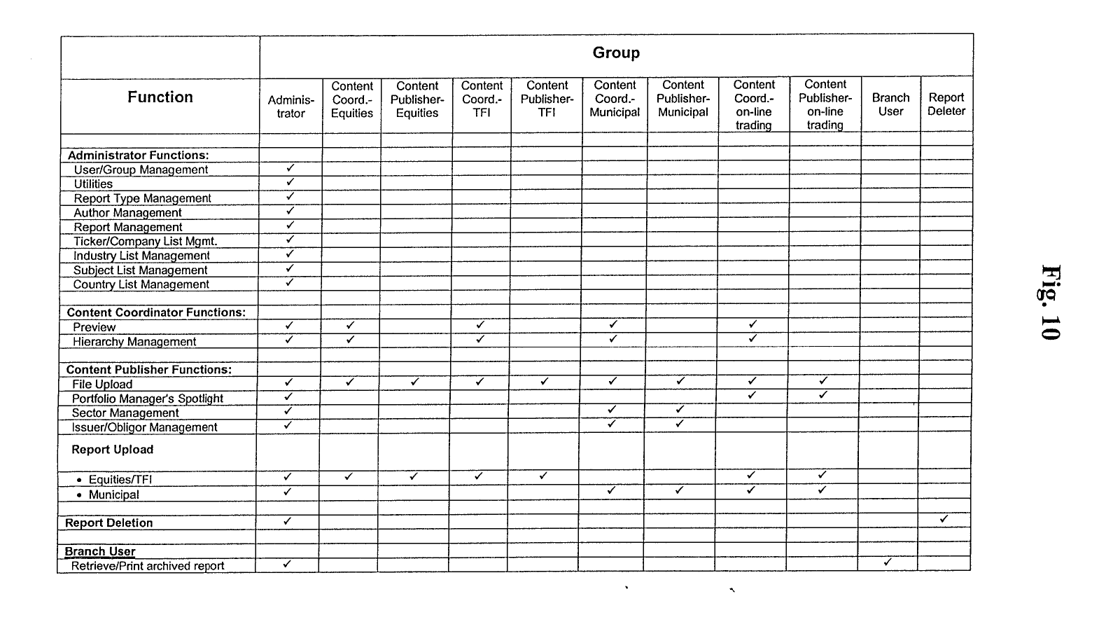

An access control tool may be used for user, group and password management. It is possible to dynamically create new user groups by selecting the CMA links and assigning them to the new user group created. Content providers log into the CMA using a CMA ID. Content providers are not allowed to make changes to the hierarchy under this ID. Likewise, hierarchy management screens will not display to Content providers or branch users. Access to certain CMA functions require entitlements which pertain to user groups. See matrix of FIG. 10 for an example listing of links enabled by group. The groups may include: (1) content coordinators (CC); (2) content providers (CP); (3) administrators (Admin); (4) document deleter and (5) branch user (Branch).

It is possible to entitle individual users to multiple user groups. For example, a given user could be given CC—equities entitlement and report deleter entitlement and all links within CC—equities and report deleter would be enabled.

Users can access the following functions:

a) User/Group Management

b) Utilities

c) Report Type Management

d) Report Management

e) Author Management

f) Preview

g) Hierarchy Management

h) Sector Management

i) Issuer/Obligor Management

j) File Upload

k) Portfolio Manager's Spotlight Edit

1) Report Upload—Equities/TFI

m) Report Upload—Municipal

n) Report Deletion

o) Ticker/Company List Management

p) Industry List Management

q) Subject Management

r) Country Management

s) Index page number of reports to display management

These functions are pre-established to user groups (see FIG. 10). The entitlement assigned to a user determines the functions the user has upon authentication. Only those areas of the site map entitled to the user will be displayed.

(2) Entitling User Groups to Site Map

A function to entitle nodes on the site map to user groups may be provided. The function enables selecting the nodes on the site map that the user may access and make edits to those nodes. All children nodes to an entitled node are automatically entitled to the group, and it is possible to entitle at any desired child node level (e.g. grandchild level. etc).

II.A Hierarchy Nodes, Content, and Content Publishing

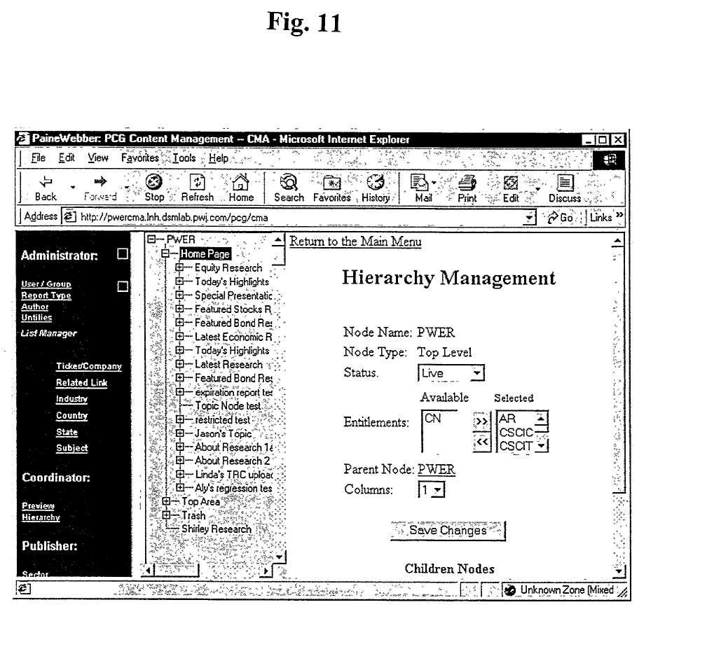

FIG. 11 illustrates a hierarchy management screen in accordance with the present invention. A left navigation bar lists various functions (i.e. hierarchy management) that are enabled according to user type (e.g., administrator, coordinator, and publisher). An entitled user may therefore manage the functions and entitlements associated with each mode type. A right column indicates various nodes and sub-nodes that have been defined. For example, a number of topic nodes are listed under the home page node. On the right side of the screen is a display that informs the user of the current node name and node type that has been selected. Additionally, drop boxes and windows are provided to allow the user to set characteristics of the node, as described further below. This display area shows the data entry fields of the selected function. For example, status may be set (staging, live or archived), entitlements may be set, the parent node may be indicated, and children node may also be set/added. Exemplary node types are discussed below.

Trunk Node This is the main node, which in the present example is named PWER. This entry is pre-defined on the hierarchy, with the “lower” nodes, e.g., an OLS home page, a PCG home page, area nodes, trash, and the help node, hanging or extending therefrom. As a security measuring the values contained in this node are protected from any level of CMA end-user.

Home Page Nodes

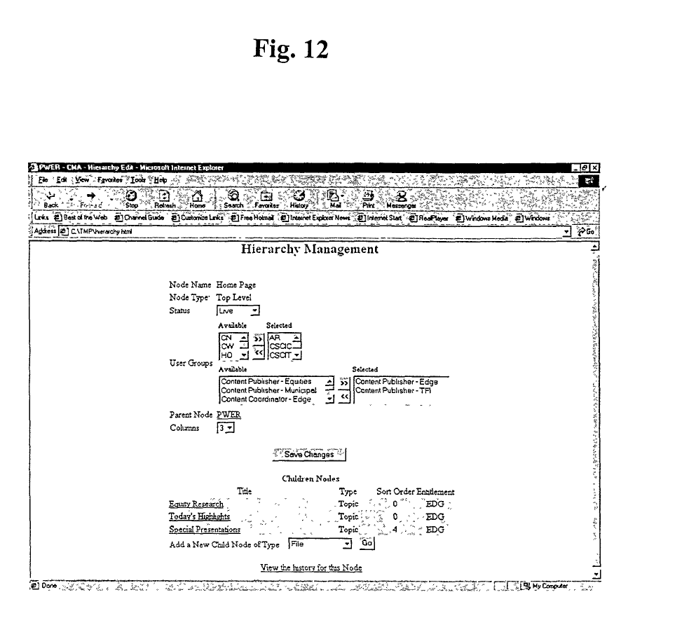

FIG. 12 illustrates a hierarchy management home page node screen in accordance with the present invention. One or more home page nodes may be defined with each appearing on the same level in the hierarchy. By way of example, organizations that enable clients to access an on-line trading web site to buy and sell securities would have an on-line trading services (OLS) home page. The organization may provide a separate enhanced web site for preferred clients in a private client group (PCG) home page.

The immediate children to the home page nodes are topic nodes. As an illustration, topic nodes include equity research, today's highlights, and special presentations are provided in FIG. 12. Here, the three example topics are entitled to a broker workstation platform. Thus, users of a broker workstation platform can access the content associated with the three topic nodes.

A global function titled “Home” allows all end-user to return to the home page regardless of location in the site. The name of the node may be managed through the CMA. The home page display template (CDA) displays each topic node from top to bottom and then left to right according to designated sort order. The number of nodes within each column is evenly distributed depending on the total number of nodes in “live” status. The number of columns that display can also be selected.

Example fields under hierarchy management include: node name, node type, node heading text, status, entitlements, parent node, number of columns, button to save changes, table of children nodes, function to add child nodes, function to view history for node, and link back to main menu on CMA.

Report Display Node

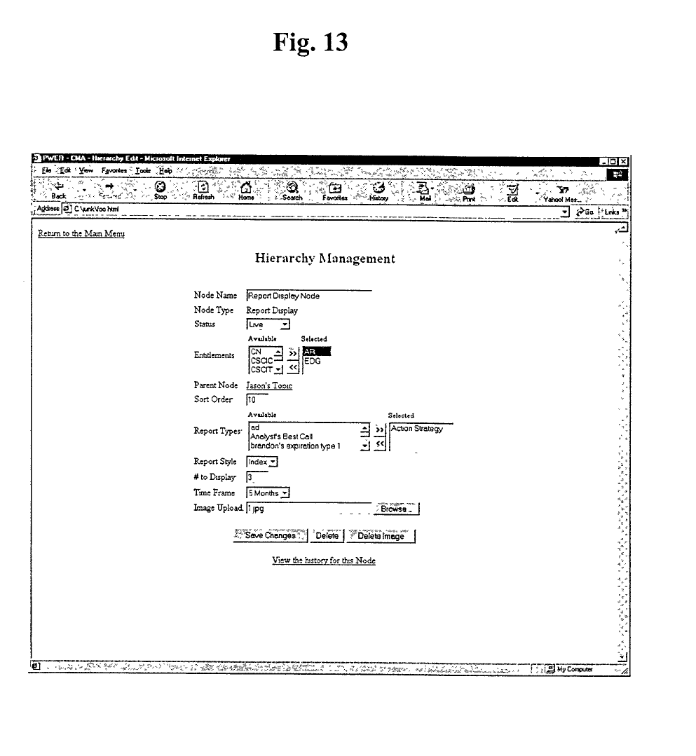

FIG. 13 illustrates a report display node screen in accordance with the present invention. Report display node management enables creating/editing of report display nodes. This node allows control of the report classification(s) displayed on the CDA and the location of the display. Report display node management enables choosing whether reports are displayed individually, or linked to other reports. In addition, it is possible to select the number of reports that are desired for display as well as the time period over which the reports will be displayed.

Fields used for managing report displays under hierarchy management include: node name, node type, status, entitlements, parent node, sort order, report type(s) to display, report style (index or link), # display (number of reports to display for link type), Time frame (time period over which reports are considered for display—e.g., today, one day, two days, etc.), button to save changes, button to delete node (node may only be deleted if there are no children nodes), function to view history for node, and link back to main menu on CMA.

File Node

File nodes enable the display of a specific file on the CDA. Once the file node is created via the CMA, a content provider can upload a file to the specified node. Although file nodes are created via the CMA, nothing displays on the CDA until a file is uploaded to the node.

Fields/items used to manage file nodes under hierarchy management include: node name, node type, status, entitlements, parent node, current file (the file that is uploaded to the node, if applicable), sort order, save changes button, delete button, function to view history for the node, and link back to main menu on CMA.

Function Node

A number of functions may be pre-created, e.g., focus list, portfolio manager's spotlight, highlighted list, strong buy list, buy list, hold list, reduce list, sell list, EVM rank list, restricted list, employee restricted list, ratings changes, and blue sky function node and custom page function node. In this instance, these function nodes would also be available via a CMA “function node type” list.

As an example, when a user selects the “blue sky function node” link, a box appears requesting a ticker or security number. When the ticker or security number is entered, blue sky information (state laws regarding securities) is returned.

Managing function nodes under hierarchy management include the following fields: node name, node type, status, entitlements, parent node, sort order, template (the specific function template to use for this function node), button to save changes, button to delete node, function to view history for node and link back to main menu on CMA. Function nodes are pre-established CDA templates whose display location may be managed via the CMA.

Related Link Node

A related link node provides a means to set up links to other nodes. The links may be one of three types: internal (internal CURL—content will appear in the center frame), external (external URL—will open in a mid-sized browser window), or external inline (external URL—content will appear in the center frame). Internal links are created by selecting the node on the site map (tree) to which the user would like to link. The node name displays on the CDA as the link to the related link.

The following fields appear when managing link nodes under hierarchy management: node name, node type, status, entitlements, parent node, sort order, link type (internal, external, external inline), link text, protocol (http/https), link location, button to preview the URL, button to save changes, button to delete node, function to view history for node and link back to main menu on CMA.

Topic Node

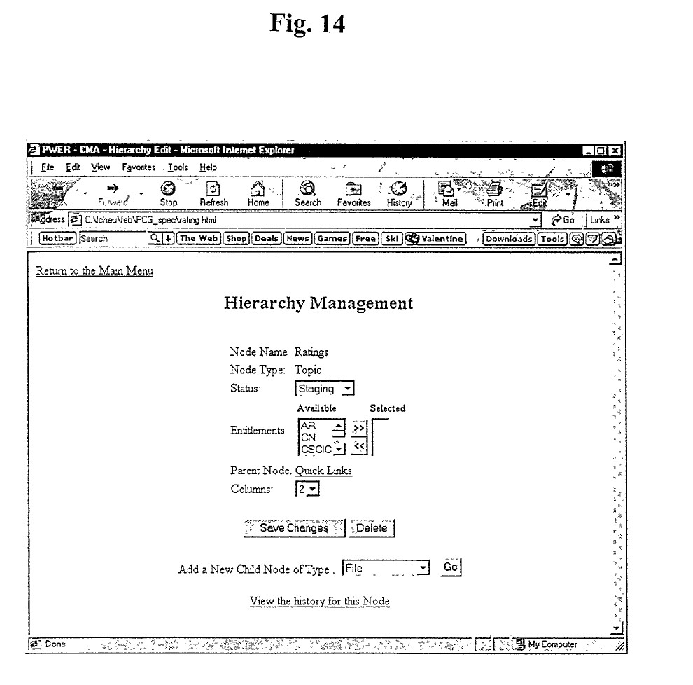

FIG. 14 illustrates a topic node screen in accordance with the present invention. As previously discussed, topic nodes are displayed on the homepage(s), or on area nodes. A number of node types may be created as children to topic nodes. These include report display nodes of all types (link or index), related link nodes, function nodes (including portfolio manager's spotlight), and file nodes.

The CDA filters topic nodes based on entitlements. A given topic node will not display if its children not in “production” (e.g., active/live, as discussed in greater detail later).

Fields available during topic node creation/editing include: node name, node type, status, entitlements, parent node, sort order, button to save changes, button to delete node (only appears if node does not have any children node), Table showing all children nodes to this node, Function to add a child node to the topic node, Function to view history of the node, and Link back to Main Menu of the CMA.

A topic node is a child node to area node.

Right Box Node

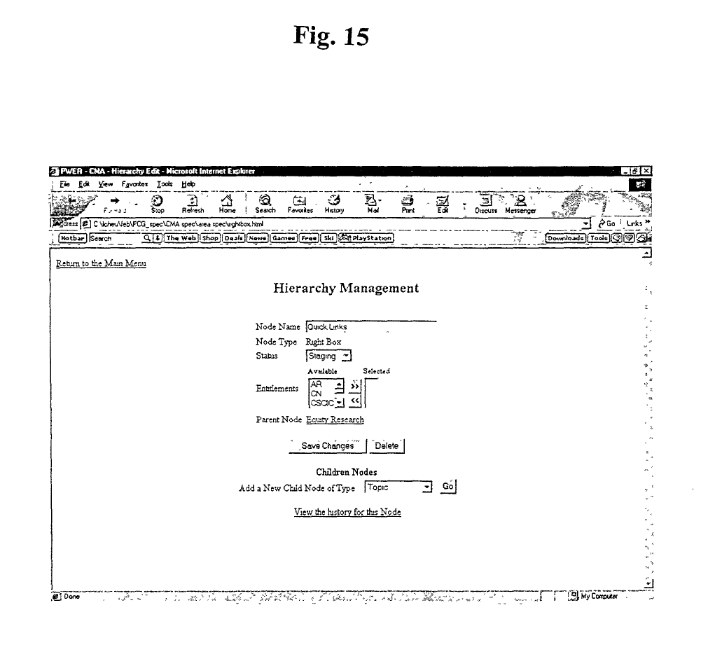

FIG. 15 illustrates a right box node screen in accordance with the present invention. The right box node enables a CMA user to create links (“quick links”) using any of the following node types: report display, file, function, link (permissible children to right box nodes). The number of right box nodes is not limited and the order with which they are displayed is determined by sort order (right box nodes will display from top to bottom).

Fields available during topic node creation/editing include: node name, node type, node status, entitlements, parent node, sort order, number of columns, button to save changes, button to delete node (only appears if there are no children nodes), children nodes, drop-down list for adding children nodes, link to view history on node, and link back to main menu of CMA.

A right box node is a child node to area node.

Area Node

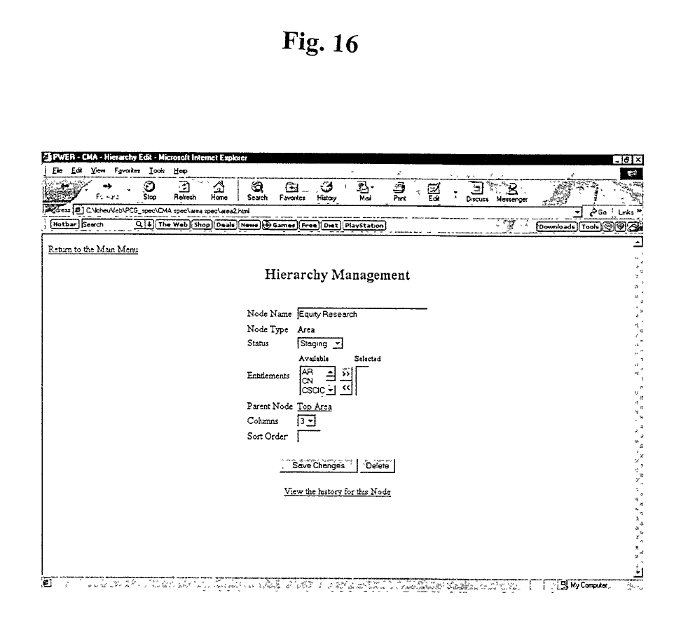

Content coordinators and admin users can create and modify area nodes, such as for the example areas of equity research, taxable fixed income research and municipal securities research. FIG. 16 illustrates an area node screen in accordance with the present invention. Area nodes are dynamically created and may only be children to the “top area” node, as indicated by the parent node field in the figure. The “global” function bar appears at the top of the screen for every area, including the home page. The node name appears at the top of the area on the CDA

Only topic nodes and right box nodes may be children nodes to area nodes.

Fields available during topic node creation/editing include: node name, node type, node status, entitlements, parent node, number of columns, sort order, button to save changes (commits the user's changes to the database), button to delete node (only appears if there are no children nodes), children nodes, drop-down list for adding children nodes, link to view history on node, and link back to main menu of CMA. The history allows users to see who has modified the node or content associated with the node and the date/time such revisions were made. If the node is a file node or report display node, it allows the user to see all documents that have been associated to the node in the past (the archive).

Queries from database tables are made to get node details such as node status, entitlements, parent node name, column number and children nodes details: node title, node type (in this case, node type is area) and sort order.

Authorized users can add a new child node by selecting an area node type from the drop down list. Clicking on a “go” button will load up another node view/edit screen. The user can create a new area node by adding a node name, e.g., “equity research,” entitlement and sort order, column number, and so forth.

The view/edit page shows the node name created, e.g., “equity research,” node type: area. The user can select status, entitlements and sort order. If the user selects “yes” to has right bar, he/she has two node types: topic node and right bar node to add as child node of this area node, and can have as many as topic nodes as desired under this area node. Only one right bar node is used.

Referring back to FIG. 15, authorized users can also add a new child node through an area node in a hierarchy management CMA screen or on site map. As shown in FIG. 15, the path works through the node view/edit screen to enter and edit all dates.

Text Node

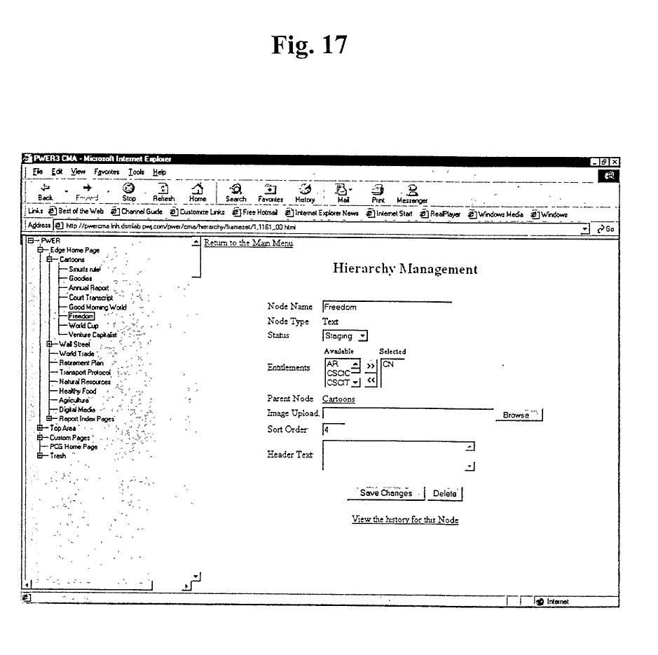

Content publishers/providers may create and modify text nodes, which may be a child to topic nodes and right box nodes. (See FIG. 17) This node type enables administrators to enter text that appears within the content location specified by sort order. (Users are given a field to specify the text desired for display on the CDA.) It is possible for users to embed links within the text by entering the appropriate URL within HTML tags.

Fields displayed on the screen when managing text nodes under hierarchy management may include: node name, node type, status, entitlements, parent node, text node text, sort order, save changes button, delete button, function to view history for the node, and link back to main menu on CMA. Text nodes are also available on CDA, under any topic node.

Custom Page Function Node

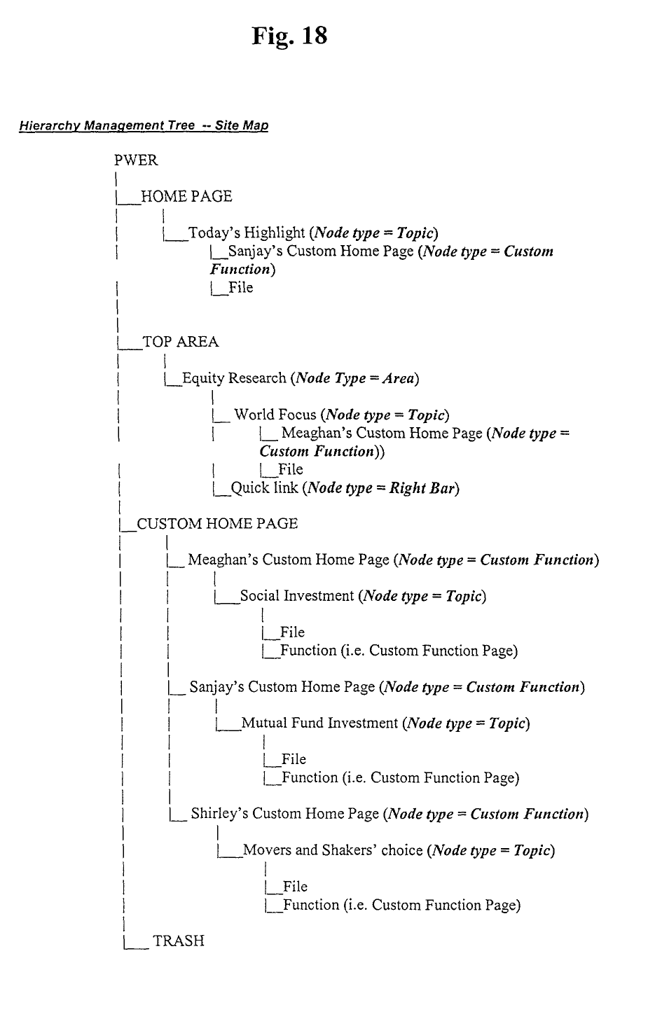

FIG. 18 illustrates a hierarchy management tree for creating a custom page function node in accordance with the present invention. The custom page function node enables content coordinators (area administrators) to create a customized content page with set limitations on the appearance of the final page. The custom function node may be created as a child node to the same node types as report display, link, text, file, and other function nodes. The custom function node name will appear on the CDA as the link to the custom function node page.

Fields available during topic node creation/editing include: node name, node type, node status, entitlements, parent node, number of columns, sort order, button to save changes, button to delete node (only appears if there are no children nodes), children nodes, drop-down list for adding children nodes, link to view history on node, link back to main menu of CMA.

A number of the functions may be provided by the CMA. By way of example, the following non-exhaustive list of functions is provided.

Report Upload

Report upload enables content publishers to upload report files such as PDF, HTML, RA and video files to the system. Tagging tools may be used to tag the files, e.g., to designate entitlements, via a report upload screen. Tagging essentially associates entitlement data with a content file, and is achieved using various techniques known to those skilled in the art.

Reports that are uploaded are displayed on the CDA by creation of report display nodes through the CMA. That is, report categories are created to which files are uploaded, and then report display nodes are created before reports are displayed.

File Upload

File upload enables content publishers to upload files such as PDF, XLW, HTML, RA (Real Audio for morning call), AVI, MS Office 97 (XLS, PPT, DOC), and video files to a specific file node in the system. A file node is first created through hierarchy management. Fields on a file upload screen may include: current file (file currently uploaded to the file node, if any), file (to upload, with browse), title, description, search keyword(s), pages, expiration date (default to six months), publisher (user who published the file), button to upload file, button to delete file, button to cancel, link back to main menu on CMA, and file node the particular file is being uploaded to. File upload enables choosing the file node uploading to via the site map/tree.

Report Type Management

Report type management through the CMA enables creation/editing of report types to which publishers may post items/content (e.g., using PDF, HTML, and RA). Once a report type is created, the report type will appear in the drop down list in report upload when publishers/content providers post reports. Report type management enables creating the classification, choosing entitlements for the classification, naming the classification, and editing report classification characteristics.

Fields which include: report type, type ID, type name, expiration interval (in days), status, entitlements, search area, restricted list block (whether report type should be blocked if primary ticker is on restricted list), button to save changes, and link back to main menu on CMA.

Portfolio Manager's Spotlight

The portfolio manager's spotlight may include research or other information on a subject that is highlighted to the user, such as information on a particular stock or industry.

The CMA control template gives the publisher the ability to change/delete/add the files loaded to the page as well as the featured portfolio manager.

The portfolio manager's spotlight content edit screen enables control of the items that appear on the CDA for the page, as well as how many links appear. In this particular example, the three main sections that can be controlled are: (1) investment viewpoint and economic outlook; (2) spotlight on . . . , and (3) other portfolio manager's spotlight reports. For a first section of the screen, the edit screen enables control of: (1) the section (investment viewpoint and/or economic outlook) that appears on the CDA, and (2) the number and specific files to be uploaded (the number of featured items, which can change each week, can be more than one for each person) for the week. For a second section of the screen, the edit screen enables control of: (1) the number of files featured that week, and (2) the specific files published for that week.

For a third section of the screen, the edit screen enables control of: (1) the number of files be featured that week, and (2) the specific files published for that week.

Node Title/Report Title Display

The following rules are used to control display on the CDA based on information entered through the CMA during node creation and/or document upload: for function, topic, file, report display of index type, report display of individual reports (i.e., link type) with only one report chosen for display, and link nodes, the node title is displayed. for report display of individual reports (i.e., link type) with more than one report chosen for display, report listing (results of selecting index page), or for search results, the report title: headline is displayed. In any other instance that a link directly to a report is displayed (e.g., report index pages, search results, report deletion on CMA, etc.), the title: headline will appear.

Image Upload

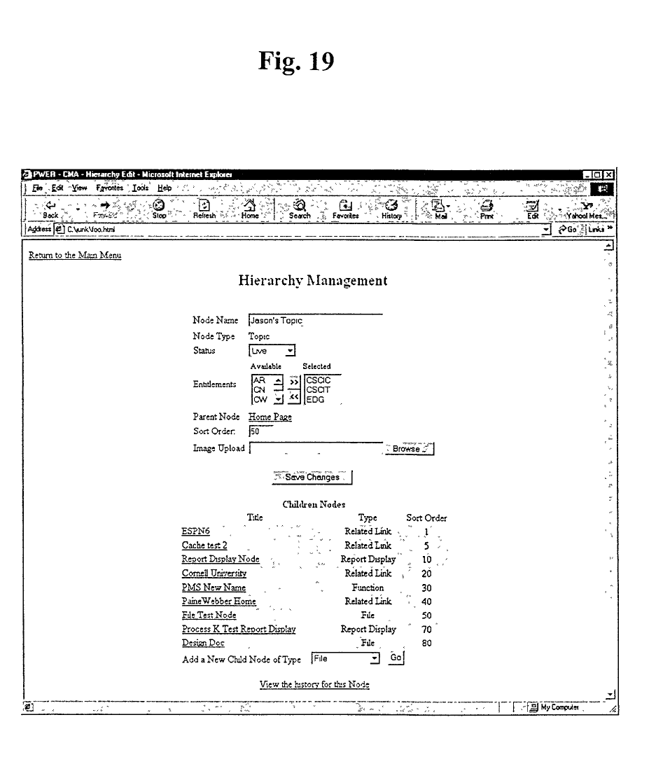

FIG. 19 illustrates an image upload screen in accordance with the present invention. This function allows users to upload images to the following node types: report display node (index type only), related link node, text node, file node, and function node (including custom function node). This feature is entitled to content coordinator type users and accessible through the hierarchy management. This function allows a user to assign an image to the previously mentioned nodes for display purposes.

A standard image size is determined. Any image uploaded will be resized proportionately to this standard size. The image is viewed through the CDA, and appears to the top, left most portion of the node's content area. Any text associated with the node (link text, etc.) is placed to the top most portion of the node's content area and immediately to the right of the image. If any child node to a topic node has an image uploaded, then all links within other child nodes to the topic node is indented to align with the text within the node containing the image.

A BROWSE function can be added to the hierarchy management template to facilitate the image upload. The user is able to select the image off a workstation and assign it to a report display node, related index node, text node, file node, or function node. The image inherits the traits of the parent node (i.e., if the parent node is staging, the image will not be displayed, and if the parent node is live, the image will be displayed).

In addition, a new field may be used to store the DFS location of the image as well as its filename. Conversely, a user can remove the image from a node. Removal of an image deletes the image from DFS and removes the entry from the database.

Document Deletion

When creating a new user, an administrator may select whether or not a link to the CMA appears on the CDA after new user log in. This is accomplished by enabling the selection of multiple user groups per user (see user group discussion under Site Map/Tree below).

Trash Can

This portion of the hierarchy is used to place nodes eliminated from the hierarchy. This node type is configured so that its contents can only be viewed on the CDA by administrators.

Staging Site

The CMA provides a “staging site” which supports dynamic hierarchical updates. All new nodes have a “staging” status. Changes only take effect on production site after a node has been promoted to live status. Removing a hierarchy node without content (i.e., in a child node), causes the status of the node to become “archived.” Changes take effect immediately on the production site after a warning has been issued to the CMA user. It is not be possible to delete a node if any nodes (whether live or not) exist as children to the node. In addition, all changes to the hierarchy, once placed into “production,” may be reflected in real-time on the CDA.

Report Management (Manage Report Meta Data)

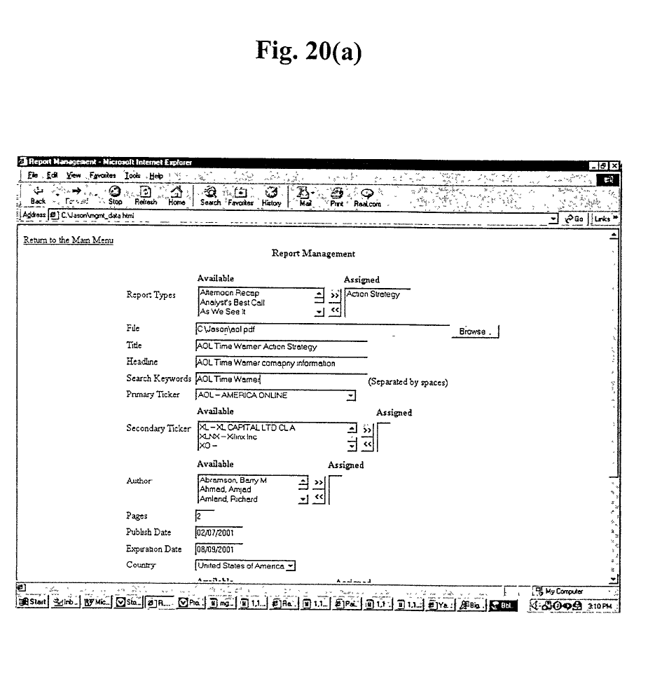

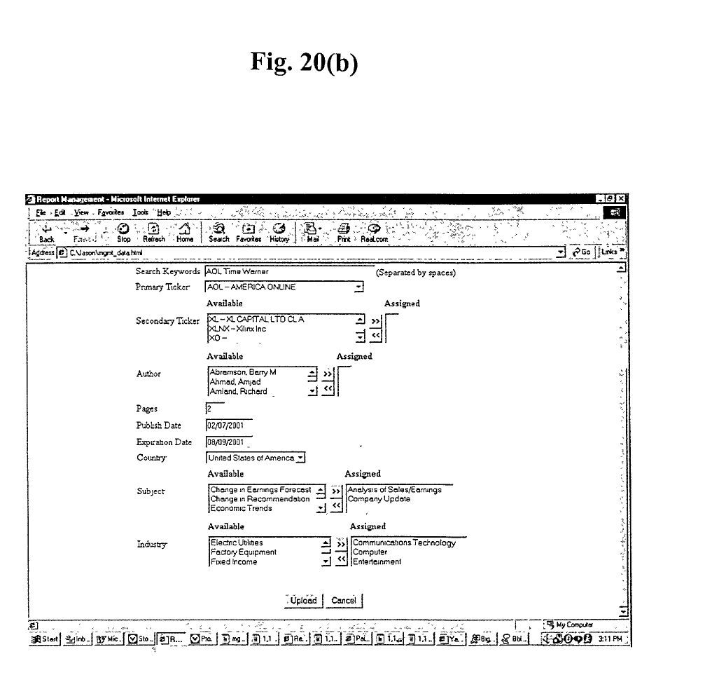

The CMA allows a user to search and review reports. As an additional feature, a user may revise the meta data associated with a given report. FIGS. 20(a) and (b) illustrate a screen that enables modification of the meta data associated with reports. This function affords administrators the ability to view/edit/change all meta data associated with a given uploaded report.

By way of example, the following meta data can be viewed/edited/changed through this screen:

(1) Fields for equities & TFI report management: file (to upload, with browse), title, headline, search keyword(s), primary ticker/company name, secondary ticker/company name, entitlement, author, number of pages, publication date (defaults to current date but may be changed; may enter a future date but then the report should not display on CDA until the date entered; a warning message is displayed if a future date is entered, warning the user that a future date has been entered), expiration date, country, subject, industry, and

(2) fields for municipal securities report management: report type, file, title, headline, search keyword(s), primary issuer/obligor, secondary issuer/obligor, entitlement, author, number of pages, publication date, expiration date, country, state, subject, sector, and high yield.

Other Management Functions

The following management functions are necessary using the list management function model provided in the CMA: manage company/ticker list, manage industry list, manage subject list, and manage country list

Preview

A function is built into CMA for the preview home page. A preview function is necessary to access every area that currently exists or that may exist through the dynamic creation of areas. These include: OLS home page, PCG home page, about research, custom page function pages, and all areas, including right bar and any new areas that may be added in the future.

II.B. Node Management

Node Status

As discussed briefly above, a node can have the following status:

(1) “staging”—this node is only visible as part of the staging site. A staging site is a location where display nodes are held prior to being in “production” or “live”;

(2) “live”—this node is visible as part of all sites (staging, production, and archive). A node has a production status only if all nodes above it in the hierarchy have a production status. Accordingly, a node will have a status of “production” if it has an associated document or a child node, which also has a “production” status; or

(3) “archived”—a node, which has been explicitly removed via the CMA, and is only visible via the “staging” site.

Node Meta data

The CMA allows a content coordinator to add and update the meta data of a hierarchical node and upload published items. Meta data may be updated with or without updating the associated content document. All changes to meta data are logged (including changes to report meta data

Change Monitoring

An audit log may be created to track all changes that occur through the CMA. The log contains the following data, as well as any other CMA change): (a) the user id which initiated the modification, (b) the IP addresses the user was logged onto when the modification was initiated, (c) the dates and time the modification occurred, and (d) a description of the change. (Such data must be accessible to administrator for report and file uploading and deletion.)

A site administrator has access to the audit log of such changes through the CMA.

Site Map/Tree

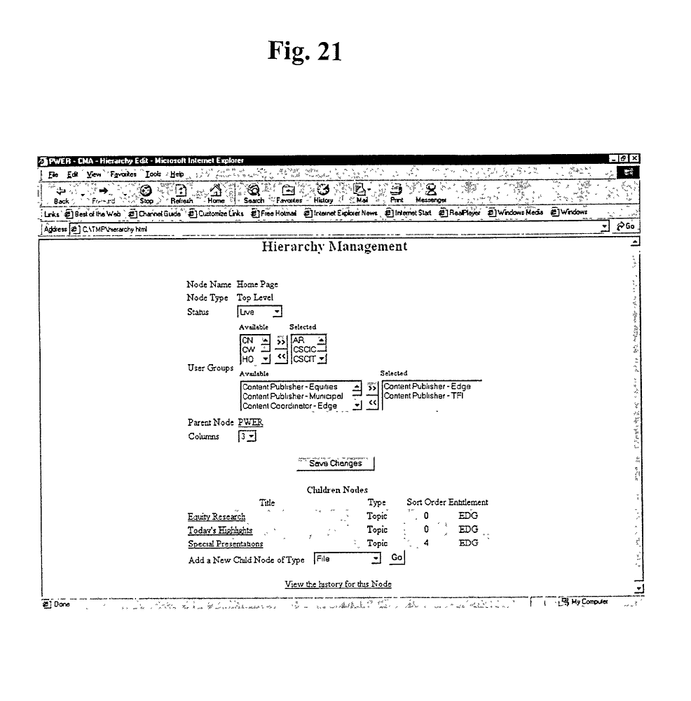

FIG. 21 illustrates a site map available for selecting nodes. When a node is selected, the node view/edit screen appears. The fields vary depending on the type of node selected. In addition, the functionality and fields available by selecting a node on the site map vary depending on user function (content coordinator vs. content publisher). Accessible nodes are based on entitlements. Items on the site map are listed within nodes in sort order. Nodes that are in “live” status are clearly indicated on the site map (e.g., by different color, etc.) A field in the table indicating children to a given node is included to provide node status as well.

Individual user groups/content providers are entitled to nodes within the CMA as determined by the site administrator. The administrator is able to select a particular user group and point to the areas of the site map the user is entitled to access. All children nodes to the node selected are also entitled to the user when selected by the administrator, and entitlements may be made at any child level desired. Such entitlement may be edited by the administrator as required. Further, such entitling is possible at any child level specified by the administrator.

Advantageously, the CMA limits the display of the site map to those areas to which user is entitled. Certain users (e.g., admin. type users) will have the entire site map available.

List Management

This feature provides “one-stop” management of all lists (e.g., company/ticker, industry, country, and subject). Thus, one single content entry template allows the user access to a single point of list management. The “list management” page view is divided into two areas: menu and data entry sections. The menu section displays all the list names while data entry area shows the data fields associated with each list name from the menu, plus the action buttons (e.g., SUBMIT, EDIT, UPDATE)

Index Reports Display Management

This function allows the administrator to globally manage the number of reports displayed on a page. A link from the main menu brings the user to a new management screen. The user is then able to enter the number of reports for display.

Utilities

Exemplary utilities provided by the CMA include:

(1) Administrator utilities (user/group management, report type management, author management, site utilities (clear page cache, rebuild verity collection database, etc.), ticker/company list management, industry list management, subject list management, country list management, report management (ability to change meta data assigned to report that has already been uploaded));

(2) Utilities for areas (e.g., equities, TFI, municipals), including sector list management (muni only), and issuer/obligor management;

(3) Entitlement management; and

(4) The ability to view a CMA user list (an alphabetized email address list of every CMA user).

Accordingly, it can be seen that the present invention provides a system and method that enables content providers to self-publish content accessible via an on-screen display of a computer workstation. The invention is particularly useful, for example, by a financial services organization in allowing content providers to feature finance-related research on the display for a financial advisor or a client. To manage the content from different content providers in the organization, a content management application is used to create a hierarchy of nodes according to subject area and other criteria, such that the information from the different content providers may be uploaded to specified nodes. A content display application allows the uploaded content to be viewed by entitled users.

Having thus described invention in full detail, it will be recognized that such detail need not be strictly adhered to but that various changes and modifications may suggest themselves to one skilled in the art, all falling within the scope of the invention, as defined by the subjoined claims.

What is claimed is:

1. A method for providing financial services data in a communications network comprising:
providing a content management application that defines a hierarchy of nodes including topic nodes arranged by topic, and enables a plurality of different content providers to publish financial services related content by uploading content to specified ones of the nodes via the communications network; and
providing a content display application for displaying the uploaded content on a computerized workstation in the communications network via an on-screen display.

2. The method of claim 1, wherein the on-screen display comprises a composite display having respective regions that are reserved for displaying uploaded content from respective ones of the content providers.

3. The method of claim 1, wherein the content management application enables users to be entitled to access content associated with specific ones of the nodes.

4. The method of claim 1, wherein the topic nodes are children nodes of a home page node.

5. The method of claim 1, wherein the content management application enables an administrator to set entitlements for the nodes such that only specified content providers are permitted to upload their content thereto.

6. The method of claim 1, wherein the content management application enables users of specified platforms to be entitled to access content associated with specific ones of the nodes.

7. The method of claim 1, wherein the content management application enables assignment of the nodes to a status of staging, live and archived.

8. The method of claim 7, wherein a new node is initially assigned the staging status prior to being placed into production;
a node is assigned the live status when placed into production; and
a node is assigned the archived status when removed from production.

9. The method of claim 1, wherein the content management application enables the tagging of content by the associated content provider to denote a required entitlement level thereof.

10. The method of claim 1, wherein the hierarchy of nodes includes a home page node.

11. The method of claim 1, wherein the hierarchy of nodes includes a report display node that enables control of report classifications for classifying the content that is displayed, and where the report classifications are displayed on-screen.

12. The method of claim 1, wherein the hierarchy of nodes includes a report display node that enables control of the content display individually or via a link.

13. The method of claim 1, wherein the hierarchy of nodes includes file nodes to which the content may be uploaded.

14. The method of claim 1, wherein the hierarchy of nodes includes function nodes comprising financial-services related topics.

15. The method of claim 14, wherein the function nodes comprise pre-established templates for use by the content display application; and
display locations of the templates may be managed via the content management application.

16. The method of claim 1, wherein the hierarchy of nodes includes related link nodes for providing at least one of internal and external links for the associated content.

17. The method of claim 1, wherein the content display application controls access to the topic nodes based on entitlements thereto.

18. The method of claim 1, wherein the hierarchy of nodes includes area nodes for content related to at least one of equities and fixed income financial instruments.

19. The method of claim 1, wherein the topics hierarchy of nodes includes custom page function nodes for enabling the content providers to create respective customized content pages for display.

20. The method of claim 1, wherein the hierarchy of nodes includes a report upload node for defining report classifications to which the content may be uploaded by the content providers.

21. The method of claim 20, wherein the content providers are enabled to upload reports to multiple report classifications.

22. The method of claim 1, wherein the hierarchy of nodes includes a content edit screen which enables the respective content providers to select files that are uploaded to a spotlight page to feature specific content.

23. The method of claim 1, wherein the hierarchy of nodes includes a report management function that allows an administrator to modify meta data associated with uploaded content.

24. The method of claim 1, wherein the content management application enables tagging of the uploaded content by the different content providers to indicate a required user entitlement level thereof for viewing the uploaded content on the workstation via the on-screen display.

25. The method of claim 1, wherein the content management application enables uploading of content by the content providers via respective computerized workstations in the communications network.

26. The method of claim 1, wherein the uploaded content comprises at least statistics, reports and ratings for a financial instrument.

27. The method of claim 1, further comprising providing a search capability via the on-screen display to enable a user to enter a search term, and to perform a search to obtain content in response thereto and specific thereto.

28. The method of claim 27, wherein the search term designates a financial instrument.

29. The method of claim 27, wherein the content obtained via the search is filtered according to an entitlement level of a user of the workstation.

30. The method of claim 1, wherein the content management application enables the content providers to specify links to uploaded content via the on-screen display.

31. A system for providing financial services data in a communications network in an organization, comprising:
a content management application that defines a hierarchy of nodes including topic nodes arranged by topic, and enables publishing of financial services related content by a plurality of different content providers associated with the organization by uploading content to specified ones of the nodes via the communications network; and
a content display application for displaying the uploaded content on a computerized workstation in the communications network via an on-screen display.

32. A computer program product for providing financial services data in a communications network in an organization, comprising:
a computer usable medium having computer readable program code means embodied therein for providing a content management application for displaying financial-services related content in the communications network via an on-screen display;
the computer readable program code means comprising means for executing instructions at a computerized workstation that defines a hierarchy of nodes, including at least topic nodes arranged by topic, and enables publishing of financial services related content by a plurality of different content providers associated with the organization by uploading content to specified ones of the nodes via the communications network;
wherein the uploaded content is adapted for display via a content display application on the on-screen display.
